(19) United States
(12) Patent Application Publication
(10) Pub. No.: US 2016/0146978 A1
(43) Pub. Date: May 26, 2016

(54) A POLARIZER PROTECTIVE FILM, A METHOD FOR PREPARING THE SAME, AND A POLARIZING PLATE COMPRISING THE SAME (AS AMENDED)

(71) Applicant: LG CHEM, LTD., Seoul (KR)

(72) Inventors: Han Na LEE, Daejeon (KR); Yeong Rae CHANG, Daejeon (KR); Jae Hoon SHIM, Daejeon (KR); Jung Hyun SEO, Daejeon (KR); Joon Koo KANG, Daejeon (KR)

(73) Assignee: LG CHEM, LTD., Seoul (KR)

(21) Appl. No.: 14/899,434

(22) PCT Filed: Jun. 20, 2014
(86) PCT No.: PCT/KR2014/005484

§ 371 Date: Dec. 17, 2015

(30) Foreign Application Priority Data
Jun. 21, 2013 (KR) 10-2013-0071738
Jun. 21, 2013 (KR) 10-2013-0071748
Jun. 19, 2014 (KR) 10-2014-0075073
Jun. 19, 2014 (KR) 10-2014-0075074

(51) Int. Cl. G02B 1/14; C09D 4/06; G02B 5/30

(52) U.S. Cl. CPC G02B 1/14; G02B 5/305; C09D 4/06

(57) ABSTRACT

The present invention relates to a polarizer protective film, a manufacturing method thereof, and a polarizing plate including the polarizer protective film. More particularly, the present invention relates to a polarizer protective film, and a polarizing plate including the same having excellent adhesion as well as showing excellent physical and optical properties. According to the polarizer protective film, and the polarizing plate including the same of the present invention, high hardness, high transparency, and high scratch resistance are provided, and thinning is possible, so that they may be easily applicable to various display devices.

### FIELD OF THE INVENTION

The present invention relates to a polarizer protective film, a method for preparing the same, and a polarizing plate comprising the same. More particularly, the present invention relates to a polarizer protective film having excellent adhesion as well as showing excellent physical and optical properties, a manufacturing method thereof, and a polarizing plate including the polarizer protective film.

This application claims priority to and the benefit of Korean Patent Application Nos. 2013-0071738 and 2013-0071748 filed in the Korean Intellectual Property Office on Jun. 21, 2013, and Korean Patent Application Nos. 2014-0075073 and 2014-0075074 filed in the Korean Intellectual Property Office on Jun. 19, 2014, the entire contents of which are incorporated herein by reference.

### BACKGROUND OF THE INVENTION

A liquid crystal display (LCD) is currently one of the most widely used flat panel displays. Generally, a liquid crystal display takes a structure having a liquid crystal layer enclosed between a TFT (thin film transistor) array substrate and a color filter substrate. If an electric field is applied to electrodes present on the array substrate and the color filter substrate, the arrangement of liquid crystal molecules of the liquid crystal layer enclosed therebetween is changed, which allows image display.

Meanwhile, on the outer side of the array substrate and the color filter substrate, a polarizing plate is provided. The polarizing plate may control polarized light by selectively penetrating light of a specific direction, among light incident from a backlight and light passing through a liquid crystal layer.

A polarizing plate generally has a structure of a polarizer capable of polarizing light in a certain direction, to which a protective film for supporting and protecting the polarizer is adhered. The polarizer protective layer is usually formed on a substrate used as a polarizer protective film.

As such protective film, generally a film consisting of triacetyl cellulose (TAC) is widely used, and as its replacement, a polyester (PET) film, a cyclic olefin polymer (COP) film, a polycarbonate (PC) film, a polynorbornene (PNB)-based film, an acryl-based film, and the like are used. Recently, particularly in order to develop an optical film having excellent mechanical properties, a film produced by a stretching process is often used.

In case of the film produced by the stretching process, adhesion is reduced for a reason such as high molecular rearrangement in the stretching process. Thus, an additional process for securing adhesion (adhesion of primer) is needed, however, in this case, another process should be added in the film manufacturing process, and physical and chemical properties are different from film to film, thereby making the development of an all-purpose primer difficult.

### SUMMARY OF THE INVENTION

### Technical Objectives

The present invention has been made in an effort to provide a polarizer protective film having advantage of representing excellent physical and optical properties, and also having excellent adhesion to a substrate, a manufacturing method thereof, and a polarizing plate including the polarizer protective film.

### Technical Solutions

An exemplary embodiment of the present invention provides a polarizer protective film including a substrate; an adhesion enhancing layer formed to erode the substrate by directly contacting the substrate on at least one surface of the substrate; and a photocurable layer formed on the adhesion enhancing layer, wherein the adhesion enhancing layer has a thickness of 1 to 10 μm, and includes a cured resin of a photocurable monofunctional monomer having a reactive group capable of hydrogen bonding.

Another embodiment of the present invention provides a manufacturing method of a polarizer protective film, including applying a first composition for forming an adhesion enhancing layer on at least one surface of a substrate; carrying out a first photocuring by irradiating the applied first composition with ultraviolet light; applying a second composition for forming a photocurable layer on the first composition cured in the first photocuring; and carrying out a second photocuring by irradiating the applied second composition with ultraviolet light, wherein the first composition includes a photocurable monofunctional monomer having a reactive group capable of hydrogen bonding, and a photopolymerization initiator, and the second composition includes a photocurable compound and a photopolymerization initiator.

Yet another embodiment of the present invention provides a polarizer protective film including a substrate; and a hard coating layer formed in direct contact with the substrate, on at least one surface of the substrate, wherein the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

Yet another embodiment of the present invention provides a polarizing plate including a polarizer; and a protective film provided on at least one surface of the polarizer, wherein the protective film includes a substrate, and a hard coating layer formed in direct contact with the substrate, on at least one surface of the substrate, the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

### Advantageous Effect of the Invention

According to the polarizer protective film, and the polarizing plate including the same of the present invention, high hardness, high transparency, and high scratch resistance are provided, and thinning is possible, so that the present invention may be usefully applicable to various display devices. In addition, the present invention may be applicable to a substrate such as not only a TAC film, but also a PET film, a COP film, a PC film, a PNB film, and a acryl-based film, without additional treatment with a primer, and its manufacturing process is simple.

### BRIEF DESCRIPTION OF DRAWINGS

FIG. 1 is a cross-sectional view showing a structure of a polarizer protective film according to an exemplary embodiment of the present invention.

FIG. 2 is a SEM image showing a cross section of a polarizer protective film according to an exemplary embodiment of the present invention.

FIG. 3 is a SEM image showing a cross section of a polarizer protective film according to another exemplary embodiment of the present invention.

### DETAILED DESCRIPTION OF THE INVENTION

The polarizer protective film of the present invention includes a substrate; an adhesion enhancing layer formed to erode the substrate by directly contacting the substrate on at least one surface of the substrate; and a photocurable layer formed on the adhesion enhancing layer, wherein the adhesion enhancing layer has a thickness of 1 to 10 μm, and includes a cured resin of a photocurable monofunctional monomer having a reactive group capable of hydrogen bonding.

Further, the manufacturing method of the polarizer protective film of the present invention includes applying a first composition for forming an adhesion enhancing layer on at least one surface of a substrate; carrying out a first photocuring by irradiating the applied first composition with ultraviolet light; applying a second composition for forming a photocurable layer on the first composition cured in the first photocuring; and carrying out a second photocuring by irradiating the applied second composition with ultraviolet light, wherein the first composition includes a photocurable monofunctional monomer having a reactive group capable of hydrogen bonding, and a photopolymerization initiator, and the second composition includes a photocurable compound and a photopolymerization initiator.

Further, the polarizer protective film of the present invention includes a substrate; and a hard coating layer formed in direct contact with the substrate, on at least one surface of the substrate, wherein the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

Further, the polarizing plate of the present invention includes a polarizer; and a protective film provided on at least one surface of the polarizer, wherein the protective film includes a substrate, and a hard coating layer formed in direct contact with the substrate, on at least one surface of the substrate, the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

In the present invention, the terms such as first and second are used to describe various constituents, and such terms are used only for distinction of one constituent from the other constituents.

The present invention may be variously modified and have various forms. Therefore, specific exemplary embodiments of the present invention will be illustrated and be described in detail below. However, it is to be understood that the present invention is not limited to a specific disclosed form, but includes all modifications, equivalents, and substitutions without departing from the scope and spirit of the present invention.

Throughout the specification, acrylate-based refers to not only acrylate, but also methacrylate, or any derivatives wherein a substituent is introduced to acrylate or methacrylate.

Hereinafter, the polarizer protective film, the manufacturing method thereof, and the polarizing plate of the present invention will be described in more detail.

The polarizer protective film according to one aspect of the present invention includes a substrate; an adhesion enhancing layer formed to erode the substrate by directly contacting the substrate on at least one surface of the substrate; and a photocurable layer formed on the adhesion enhancing layer, wherein the adhesion enhancing layer has a thickness of 1 to about 10 μm, and includes a cured resin of a photocurable monofunctional monomer having a reactive group capable of hydrogen bonding.

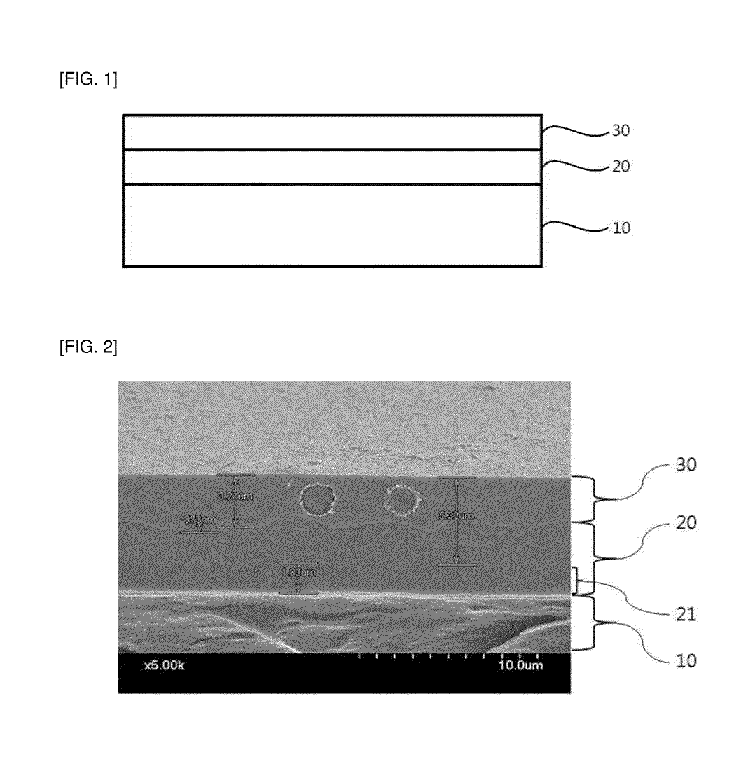

FIG. 1 simply shows a structure of a polarizer protective film according to an exemplary embodiment of the present invention. Referring to FIG. 1, it is identified that the polarizer protective film of the present invention includes a substrate 10; an adhesion enhancing layer 20 formed to erode the substrate 10 by directly contacting the substrate on at least one surface of the substrate; and a photocurable layer 30 formed on the adhesion enhancing layer 20.

If the adhesion enhancing layer has a thickness less than about 1 μm, it may not sufficiently serve as an enhancing adhesion layer, and if it has a thickness above about 10 μm, it may not satisfy the requirement of flexibility and thinning. The adhesion enhancing layer may preferably have a thickness of about 2 to about 5 μm.

The polarizer protective film is used to protect a polarizer from outside.

The substrate commonly used in the polarizer protective film may be exemplified as a substrate consisting of a polyester film such as a polyethylene terephthalate (PET) film, a cyclic olefin copolymer (COC) film, a polyacrylate (PAC) film, a polycarbonate (PC) film, a polyethylene (PE) film, a polymethylmethacrylate (PMMA) film, a polyetheretherketone (PEEK) film, a polyethylene naphthalate (PEN) film, a polyetherimide (PEI) film, a polyimide (PI) film, a triacetyl cellulose (TAC) film, or the like.

Among those substrates, particularly the triacetyl cellulose (TAC) film is widely used with its excellent optical properties. In case of using the TAC film alone, it has weak surface hardness, and is vulnerable to humidity. Thus, it is used with a functional coated layer such as a hard coating added, or instead of using the TAC film, a polyester (PET) film, a cyclic olefin copolymer (COP) film, a polycarbonate (PC) film, a polynorbornene (PNB)-based film, an acryl-based film, or the like is used. Recently, especially in order to develop an optical film having excellent mechanical properties, a film produced by a stretching process is often used.

In case of the film produced by a stretching process, since its adhesion to the polarizer protective layer and the like is reduced by a reason such as high molecular rearrangement, an additional process (such as primer adhering) is required in order to secure adhesion. In this case, an additional process should be added in the manufacturing process of the film, and an all-purpose primer is difficult to be developed due to different physical and chemical properties from film to film.

Since the polarizer protective film according to an exemplary embodiment of the present invention are provided with the additional adhesion enhancing layer, it has high hardness, high transparency, and high scratch resistance, and is capable of being thinned, while having excellent adhesion between the adhesion enhancing layer and the substrate. Thus, it may be applied without additional treatment with a primer even in the case of using a stretched film such as a PET film, a COP film, a PC film, a PNB film, and an acryl film as the substrate, in addition to a cast film such as a TAC film.

The adhesion enhancing layer includes the cured resin of the photocurable monofunctional monomer having the reactive group capable of hydrogen bonding. The photocurable monofunctional monomer having the reactive group capable of hydrogen bonding is less evaporated than a solvent, and has good reactivity, so that it is erodible on the substrate very independently of the characteristic of the substrate.

Due to such erosion of the substrate, chemical bonding between the substrate layer and the adhesion enhancing layer is possible after the erosion of the substrate. Thus, excellent adhesion may be maintained regardless of the characteristic of the substrate, without including an additional further adhesive, cross linking agent, or the like.

It is preferred that the adhesion enhancing layer is formed so that about 20 to about 50% of the total thickness of the adhesion enhancing layer including the eroded part of the substrate erodes the substrate. If the thickness of the eroded substrate by the adhesion enhancing layer is in the above range, the adhesion enhancing layer may maintain the excellent adhesion, and the polarizer protective film may maintain excellent mechanical properties such as high hardness and high transparency.

FIG. 2 is a SEM image showing a cross section of a polarizer protective film according to an exemplary embodiment of the present invention.

Referring to FIG. 2, it is identified that the polarizer protective film according to one aspect of the present invention includes a substrate 10; an adhesion enhancing layer 20 formed to erode the substrate 10 by directly contacting the substrate on at least one surface of the substrate; and a photocurable layer 30 formed on the adhesion enhancing layer 20, and particularly, the adhesion enhancing layer 20 is formed so that about 20 to about 50% of the total thickness of the adhesion enhancing layer including the eroded part of the substrate 21 erodes the substrate.

Since the adhesion enhancing layer of the present invention includes the cured resin having a reactive group capable of hydrogen bonding therein, and after curing, intermolecular hydrogen bonding is possible within an interface between the adhesion enhancing layer and the substrate, it may have better adhesion to the substrate.

As the reactive group capable of hydrogen bonding, any reactive group or residue capable of hydrogen bonding is included without particular limitation, and for example, a reactive group such as an —OH group, a —NH₂ group, a —NHR group, a —COOH group, a —CONH₂ group, and a —NHOH group, or a residue such as a —NHCO— bond, a —NH— bond, a —CONHCO— bond, and a —NH—NH— bond in the molecule, may be included. Further, in case of sites included on different resins, if the sites are capable of hydrogen bonding to each other, they are not particularly limited as a hydrogen bonding site. For example, if a reactive group or a residue including N or O is capable of hydrogen bonding to an —OH group, a —NH₂ group, or the like included in other resin, it may be regarded as being the hydrogen bonding site. Hereinbefore, R may be aliphatic hydrocarbon, aromatic hydrocarbon, and their derivatives, for example, aliphatic hydrocarbon having 1 to 16, or 1 to 9 carbons, aromatic hydrocarbon having 5 to 30, or 5 to 16 carbons, and their derivatives.

The photocurable monofunctional monomer having such reactive group capable of hydrogen bonding may include, but not particularly limited to, for example, an amino group-including monomer such as N-substituted (meth)acrylate or N,N-substituted (meth)acrylate, a hydroxyl group-including monomer such as vinyl acetate or hydroxyalkyl (meth)acrylate, a carboxyl group-including monomer such as (meth)acrylic acid, 2-(meth)acryloyloxy acetic acid, 3-(meth)acryloyloxy propylic acid, 4-(meth)acryloyloxy butyric acid, acrylic acid dimer, itaconic acid, maleic acid or maleic anhydride, a heterocyclic compound such as vinyl pyrrolidone or acryloyl morpholine, 2-ureido-pyrimidinone group-including monomer, and the like. Specifically for example, it is preferred to use, but not limited to, tetrahydrofurfuryl acrylate (THFA), tetrahydrofurfuryl methacrylate (THFMA), hydroxyethyl acrylate (HEA), hydroxyethyl methacrylate (HEMA), carboxyethyl acrylate, carboxyethyl methacrylate, and the like, and the photocurable monofunctional monomer having a reactive group capable of hydrogen bonding as described above, may be used without particular limitation.

According to an exemplary embodiment of the present invention, the photocurable monofunctional monomer may include a monofunctional monomer having a straight chain structure or a branched chain structure with a monofunctional diluent monomer having a cyclic structure, and be used either alone or in combination of different kinds thereof.

According to an exemplary embodiment of the present invention, the adhesion enhancing layer may include a cured resin of the photocurable monofunctional monomer having the reactive group capable of hydrogen bonding, and a polyfunctional acrylate-based monomer. As described above, various types of bonding may be formed by polymerizing a photocurable monofunctional monomer having a reactive group capable of hydrogen bonding with a polyfunctional acrylate-based monomer, and accordingly, the adhesion enhancing layer may have better adhesion and scratch resistance.

According to an exemplary embodiment of the present invention, the polyfunctional acrylate-based monomer may be exemplified as, but not limited to, hexanediol diacrylate (HDDA), tripropylene glycol diacrylate (TPGDA), ethylene glycol diacrylate (EGDA), trimethylolpropane triacrylate (TMPTA), trimethylolpropane ethoxylated triacrylate (TMPEOTA), glycerol propoxylated triacrylate (GPTA), pentaerythritol tetraacrylate (PETA), dipentaerythritol hexaacrylate (DPHA), and the like, and polyfunctional acrylate-based monomer generally used in the art may be used without particular limitation.

According to an exemplary embodiment of the present invention, in case where the cured resin is the cured resin of the photocurable monofunctional monomer having the reactive group capable of hydrogen bonding and polyfunctional acrylate-based monomer, about 10 to about 150 parts by weight of the polyfunctional acrylate-based monomer may be cured, based on total 100 parts by weight of the photocurable monofunctional monomer having the reactive group capable of hydrogen bonding. If the cured resin is cured in the above range, the polarizer protective film of the present invention may have sufficient flexibility and adhesion without deterioration of physical and optical properties.

According to an exemplary embodiment of the present invention, the substrate may be exemplified as, but not limited to, a polyethylene terephthalate (PET) film, a cyclic olefin copolymer (COC) film, a polyacrylate (PAC) film, a polycarbonate (PC) film, a polyethylene (PE) film, a polymethylmethacrylate (PMMA) film, a polyetheretherketone (PEEK) film, a polyethylene naphthalate (PEN) film, a polyetherimide (PEI) film, a polyimide (PI) film, a triacetyl cellulose (TAC) film, and the like, and is applicable without particular limitation, if it is generally used in the art for protecting a polarizer.

According to an exemplary embodiment of the present invention, the photocurable layer may be an anti-reflective layer, an antiglare layer, or a scratch resistant layer. However, the photocurable layer is not necessarily limited thereto, and the photocurable layer having various functions may be provided depending on the characteristics of the desired polarizer protective film.

If the photocurable layer is an anti-reflective layer or an antiglare layer, the anti-reflective layer or antiglare layer may be consisting of a film for minimizing reflection of incident light from the outside. As a method for minimizing the reflection of light, a method of dispersing filler such as inorganic fine particles in a resin to coat it on a substrate film and impart unevenness (anti-glare AG coating); a method of forming plural layers having different refractive indexes on a substrate film to use interference of light (anti-reflection AR coating); and a combination method thereof, are included. In the AG coating, the absolute amount of reflected light is in the equivalent level of general hard coating, but a low reflection effect may be obtained by decreasing the amount of light entering the eye using scattering of the light through unevenness. The film produced by using the AR coating is commercialized as a multilayered structure where a hard coating layer (a high refractive index layer), a low reflective coated layer, and the like are layered on the substrate film. The anti-reflective layer of the present invention may be formed by the AG coating and/or the AR coating, and any method generally used in the art may be used without particular limitation.

For example, the anti-reflective layer may include hallow silica particles. Since the hallow silica particles have a lower refractive index than filled particles, they have excellent anti-reflective properties. In this case, the hollow silica particles may have a number average diameter of 20 to 80 nm, preferably 20 to 70 nm, more preferably 30 to 70 nm, and the shape of the particles is preferably sphere, but an indeterminate form is also fine.

Further, the hollow silica particles may be used in combination with those which is surface-treated (coated) with a fluorine-based compound. That is, in case of surface-treating the hallow silica particles with the fluorine-based compound, the surface energy of the particles may be much lowered, thereby making the particles more evenly distributed in the composition, which may lead to more uniform scratch resistance improvement effect. A method of introducing the fluorine-based compound to the surface of the hollow silica particles may be carried out by hydrolyzing and condensing the hollow silica particles and the fluorine-based compound by a sol-gel reaction in the presence of water and a catalyst. However, the present invention is not limited thereto.

Further, the hollow silica particles may be used in a state of being dispersed in an organic solvent, wherein the solid (hollow silica particle) content of the dispersion may be determined considering the purpose of the photocurable layer, a viscosity range suitable for composition coating, and the like, and thus, is not limited.

If the photocurable layer is a scratch resistant layer, the scratch resistant layer may consist of a layer for protecting the polarizing plate and the polarizer protective film from outside. That is, the scratch resistant layer may have properties such as wear resistance and fouling resistance which are maintained even in the case of rubbing the film, and also have excellent dust removal and anti-static properties, thereby capable of protecting the polarizing plate and the polarizer protective film. Any method generally used in the art may be used to form the scratch resistant layer in the present invention without particular limitation.

For example, the scratch resistant layer may be formed by a composition including a binder resin including a photocurable functional group, a photopolymerization initiator, nanoparticles, conductive inorganic particles, and the like. The binder resin including a photocurable functional group may be a main component capable of imparting wear resistance or scratch resistance to the scratch resistant layer, and for example, an acrylate-based or vinyl-based resin may be used. Particularly, if the composition includes a fluorine-based photocurable functional group-including compound, it is useful to reduce or remove contamination by an oil component such as fingerprint marks. The nanoparticles which are a component capable of imparting fouling resistance and an anti-graffiti property to the scratch resistant layer, may be, for example, particles of silica, alumina, titania, zirconia, magnesium fluoride, and the like, wherein the diameter of the particles may be limited so as to guarantee an optical transparency. The conductive inorganic particles which are a component added for implementing excellent dust removal and anti-static properties on the scratch resistant layer, may be, for example, tin-doped indium oxide, antimony-doped tin oxide, antimony-doped zinc oxide, tin oxide, zinc oxide, and the like, wherein the diameter of the particles may also be limited so as to guarantee the optical transparency of the film.

Further, according to an exemplary embodiment of the present invention, the photocurable layer may have a thickness of about 1 to about 10 μm, preferably about 3 to about 5 μm. If the photocurable layer has a thickness less than 1 μm, it may not sufficiently serve as a photocurable layer in accordance with the purpose thereof, and if it has a thickness above about 10 μm, it may not satisfy the requirement of flexibility and thinning, since the entire polarizer protective film becomes thick.

According to an exemplary embodiment of the present invention, the polarizer protective film may further include a hard coating layer between the adhesion enhancing layer and the photocurable layer. The hard coating layer is intended to increase the hardness of the polarizer protective film, and any hard coating layer generally used in the art may be used without particular limitation.

The manufacturing method of the polarizer protective film according to one aspect of the present invention includes applying a first composition for forming an adhesion enhancing layer on at least one surface of a substrate; carrying out a first photocuring by irradiating the applied first composition with ultraviolet light; applying a second composition for forming a photocurable layer on the first composition cured in the first photocuring; and carrying out a second photocuring by irradiating the applied second composition with ultraviolet light, wherein the first composition includes a photocurable monofunctional monomer having a reactive group capable of hydrogen bonding, and a photopolymerization initiator, and the second composition includes a photocurable compound and a photopolymerization initiator.

According to an exemplary embodiment of the present invention, the substrate may be exemplified as, but not limited to, a polyethylene terephthalate (PET) film, a cyclic olefin copolymer (COC) film, a polyacrylate (PAC) film, a polycarbonate (PC) film, a polyethylene (PE) film, a polymethylmethacrylate (PMMA) film, a polyetheretherketone (PEEK) film, a polyethylene naphthalate (PEN) film, a polyetherimide (PEI) film, a polyimide (PI) film, a triacetyl cellulose (TAC) film, and the like, and any substrate generally used for protection of a polarizer is applicable without particular limitation.

According to an exemplary embodiment of the present invention, the first composition may include a photocurable monofunctional monomer having a reactive group capable of hydrogen bonding, a polyfunctional acrylate-based monomer, and a photopolymerization initiator, and the roles of the photocurable monofunctional monomer having the reactive group capable of hydrogen bonding, and the polyfunctional acrylate-based monomer are as described above regarding the polarizer protective film.

According to an exemplary embodiment of the present invention, if the first composition includes the photocurable monofunctional monomer having the reactive group capable of hydrogen bonding, and the polyfunctional acrylate-based monomer, about 10 to about 150 parts by weight of the polyfunctional acrylate-based monomer may be included, based on total about 100 parts by weight of the photocurable monofunctional monomer having the reactive group capable of hydrogen bonding. If the first composition includes the photocurable monofunctional monomer having the reactive group capable of hydrogen bonding, and the polyfunctional acrylate-based monomer in the above range, the polarizer protective film of the present invention manufactured therefrom may have sufficient flexibility and adhesion without deterioration of physical and optical properties.

According to an exemplary embodiment of the present invention, the first composition may be applied so that the adhesion enhancing layer has a thickness of about 1 to about 10 μm, preferably about 2 to about 5 μm after curing. If the first composition is applied in the above range, it may sufficiently serve as the desired adhesion enhancing layer, and the polarizer protective film having sufficient flexibility and adhesion may be manufactured.

Further, the second composition may be applied so that the photocurable layer has a thickness of about 1 to about 10 μm after curing. If the second composition is applied in the above range, it may sufficiently serve as the desired photocurable layer, and the polarizer protective film having sufficient flexibility and adhesion may be manufactured.

More detailed description of, and the examples of usable materials as the photocurable monofunctional monomer having the reactive group capable of hydrogen bonding and polyfunctional acrylate-based monomer, are as described above regarding the polarizer protective film.

The first composition includes the photopolymerization initiator.

The photopolymerization initiator may be exemplified as, but not limited to, 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, bis(2,4,6-trimethylbenzoyl)-phenylphosphine oxide, or the like. Further, as a currently commercially available product, Irgacure 184, Irgacure 500, Irgacure 651, Irgacure 369, Irgacure 907, Darocur 1173, Darocur MBF, Irgacure 819, Darocur TPO, Esacure KIP 100F, and the like may be included. Such photoinitiator may be used either alone or in combination of two or more different kinds thereof.

The photocurable compound included in the second composition, which is a compound causing a polymerization reaction when it is irradiated with light, thereby being cured, is a binder component for securing the minimum scratch resistance and wear resistance required for the photocurable layer. Any compound usually used in the art to which the present invention pertains, may be used as the photocurable compound, without particular limitation, and which may be, for example, a monomer or oligomer including a (meth)acrylate functional group, an acryloyl functional group, or a vinyl functional group.

The photopolymerization initiator included in the second composition may be identical to or different from the photopolymerization initiator included in the first composition, and the specific examples thereof are as described above regarding the first composition.

In addition, the first and the second compositions may further include an organic solvent for controlling an application property and viscosity.

As the organic solvent, an alcohol-based solvent such as methanol, ethanol, isopropyl alcohol and butanol, an alkoxy alcohol-based solvent such as 2-methoxyethanol, 2-ethoxyethanol and 1-methoxy-2-propanol, a ketone-based solvent such as acetone, methyl ethyl ketone, methyl isobutyl ketone, methyl propyl ketone and cyclohexanone, an ether-based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethyl glycol monopropyl ether, diethyl glycol monobutyl ether and diethylene glycol 2-ethylhexyl ether, an aromatic solvent such as benzene, toluene and xylene, and the like may be used either alone or in combination.

According to an exemplary embodiment of the present invention, the first photocuring step may be carried out until the photocurable monofunctional monomer having the reactive group capable of hydrogen bonding and/or the polyfunctional acrylate-based monomer included in the first composition is/are partly crosslinked. “Partly crosslinked” refers to partially crosslinked less than 100%, if the photocurable monofunctional monomer having the reactive group capable of hydrogen bonding and the polyfunctional acrylate-based monomer, being completely crosslinked in the first composition is defined as being 100% crosslinked. For example, according to an exemplary embodiment of the present invention, the first photocuring may be carried out until about 30 to about 60 mol %, or about 40 to about 50 mol % of the functional groups included in the photocurable monofunctional monomer having the reactive group capable of hydrogen bonding and the polyfunctional acrylate-based monomer in the first composition are crosslinked. After the first photocuring causing partial crosslinking, the adhesion to the substrate may be more sufficiently secured through second composition application and second photocuring, and curling or a cure shrinkage phenomenon which may occur in the course of the photocuring process, may be prevented.

A method of applying the first and the second compositions is not particularly limited, if it is usable in the art to which the present invention pertains, and for example, a bar coating method, a knife coating method, a roll coating method, a blade coating method, a die coating method, a micro gravure coating method, a comma coating method, a slot die coating method, a lip coating method, or the like may be used.

The dose of ultraviolet light in the curing process may be, for example, about 20 to about 600 mJ/cm². As a light source used in the irradiation of ultraviolet light, any source usable in the art to which the present invention pertains may be used without particular limitation, and for example, a high pressure mercury lamp, a metal halide lamp, a black light fluorescent lamp, or the like may be used.

According to an exemplary embodiment of the present invention, the manufacturing method of the polarizer protective film of the present invention may further include drying the first composition applied on one surface of the substrate, before the first photocuring.

In addition, according to another exemplary embodiment of the present invention, the manufacturing method of the polarizer protective film of the present invention may further include drying the second composition applied on the first composition cured in the first photocuring, before the second photocuring.

The drying process allows the applied surface of the composition to be planarized, and the solvent included in the composition to be vaporized, thereby capable of manufacturing the polarizer protective film having better optical properties.

According to an exemplary embodiment of the present invention, the photocurable layer in the manufacturing method of the polarizer protective film may be, but not limited to, an anti-reflective layer, an antiglare layer, or a scratch resistant layer, and changed depending on the purpose of the polarizer protective film to be manufactured. Detailed description thereon is as described above regarding the polarizer protective film.

Meanwhile, the polarizer protective film according to another aspect of the present invention includes a substrate; and a hard coating layer formed in direct contact with the substrate, on at least one surface of the substrate, wherein the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

The hard coating layer includes a cured resin of a photocurable monofunctional monomer having a reactive group capable of hydrogen bonding, a polyfunctional acrylate-based monomer, and a polyfunctional acrylate-based polymer. Since the photocurable monofunctional monomer less vaporizes than the solvent, and has good reactivity, it is possible to be eroded on the substrate much regardless of the composition of the substrate.

Due to such erosion of the substrate, chemical bonding between the substrate layer and the hard coating layer is possible after the erosion of the substrate. Thus, excellent adhesion may be maintained regardless of the characteristic of the substrate, without including an additional further adhesive, cross linking agent, or the like.

It is preferred that the hard coating layer is formed so that about 20 to about 50% of the total thickness of the hard coating layer including the eroded part of the substrate erodes the substrate. If the thickness of the eroded substrate by the hard coating layer is in the above range, the hard coating layer may maintain the excellent adhesion, and the polarizer protective film may maintain excellent mechanical properties such as high hardness and high transparency.

Further, since the hard coating layer of the present invention includes the cured resin having a reactive group capable of hydrogen bonding therein, and after curing, intermolecular hydrogen bonding is possible within an interface between the hard coating layer and the substrate, the hard coating layer may have better adhesion to the substrate.

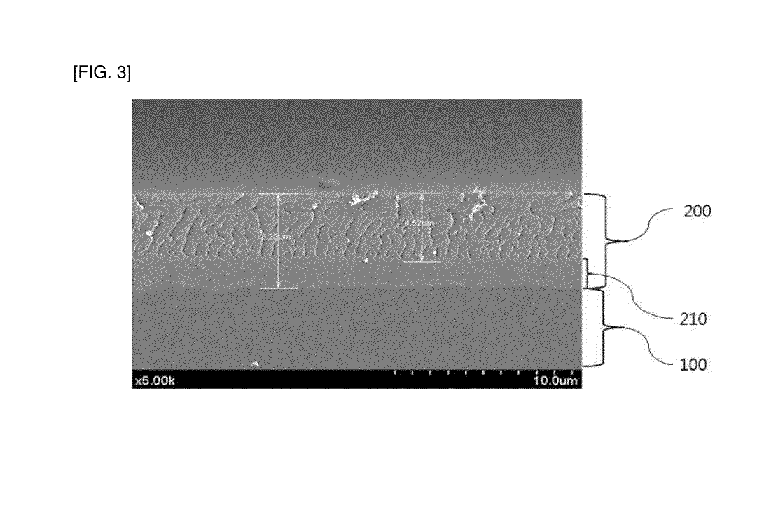

FIG. 3 is a SEM image showing a cross section of a polarizer protective film according to another exemplary embodiment of the present invention.

Referring to FIG. 3, it is identified that the polarizer protective film according to an exemplary embodiment of the present invention includes a substrate 100; and a hard coating layer 200 formed in direct contact with the substrate, on at least one surface of the substrate, and in particular, the hard coating layer 200 is formed so that about 20 to about 50% of the total thickness of the hard coating layer including the eroded part of the substrate 210 erodes the substrate.

As the reactive group capable of hydrogen bonding, any functional group, residue, or the like capable of intramolecular or intermolecular hydrogen bonding is included without particular limitation, and for example, a reactive group such as an —OH group, a —NH₂ group, a —NHR group, a —COOH group, a —CONH₂ group, and a —NHOH group, or a residue such as a —NHCO— bond, a —NH— bond, a —CONHCO— bond, and a —NH—NH— bond present in the molecule, may be included. Further, in case of sites included on different resins, if the sites are capable of hydrogen bonding to each other, they are not particularly limited as a hydrogen bonding site. For example, if a functional group or a residue including N or O is capable of hydrogen bonding to an —OH group, a —NH₂ group, or the like included in other resin, it may be regarded as being the hydrogen bonding site. Hereinbefore, R may be aliphatic hydrocarbon, aromatic hydrocarbon, or derivatives thereof, for example, aliphatic hydrocarbon having 1 to 16, or 1 to 9 carbons, aromatic hydrocarbon having 5 to 30, or 5 to 16 carbons, and derivatives thereof. The photocurable monofunctional monomer having the reactive group capable of hydrogen bonding may include, but not particularly limited to, for example, an amino group-including monomer such as N-substituted (meth)acrylate or N,N-substituted (meth)acrylate, a hydroxyl group-including monomer such as vinyl acetate or hydroxyalkyl (meth)acrylate, a carboxyl group-including monomer such as (meth)acrylic acid, 2-(meth)acryloyloxy acetic acid, 3-(meth)acryloyloxy propylic acid, 4-(meth)acryloyloxy butyric acid, acrylic acid dimer, itaconic acid, maleic acid or maleic anhydride, a heterocyclic compound such as vinyl pyrrolidone or acryloyl morpholine, or 2-ureido-pyrimidinone group-including monomer.

According to an exemplary embodiment of the present invention, specifically for example, it is preferred to use, but not limited to, tetrahydrofurfuryl acrylate (THFA), tetrahydrofurfuryl methacrylate (THFMA), hydroxyethyl acrylate (HEA), hydroxyethyl methacrylate (HEMA), carboxyethyl acrylate, carboxyethyl methacrylate, and the like, and the photocurable monofunctional monomer having a functional site capable of hydrogen bonding as described above, may be used without particular limitation. The photocurable monofunctional monomer may be used either alone or in combination of different kinds thereof.

According to an exemplary embodiment of the present invention, the hard coating layer included in the polarizer protective film may have a thickness of about 1 to about 10 μm. If the hard coating layer has a thickness less than 1 μm, it may not sufficiently serve as the hard coating layer, and if it has a thickness above about 10 μm, the total thickness of the protective film becomes thick, so that it may not satisfy the requirement of thinning.

According to an exemplary embodiment of the present invention, in the polarizer protective film, about 10 to about 80 parts by weight of the photocurable monofunctional monomer, about 10 to about 80 parts by weight of the polyfunctional acrylate-based monomer, and about 5 to about 30 parts by weight of the polyfunctional acrylate-based polymer are cured, based on about 100 parts by weight of the cured resin. If the cured resin is cured in the above range, the polarizer protective film of the present invention may have sufficient flexibility and adhesion without deterioration of physical and optical properties.

According to an exemplary embodiment of the present invention, as the polyfunctional acrylate-based monomer, any monomer generally used in the art which is an acrylate-based monomer, being curable by light, and having two or more functional groups, may be used without particular limitation. For example, hexanediol diacrylate (HDDA), tripropylene glycol diacrylate (TPGDA), ethylene glycol diacrylate (EGDA), trimethylolpropane triacrylate (TMPTA), trimethylolpropane ethoxylated triacrylate (TMPEOTA), glycerol propoxylated triacrylate (GPTA), pentaerythritol tetraacrylate (PETA), dipentaerythritol hexaacrylate (DPHA), and the like may be used, without limitation, and any polyfunctional acrylate-based monomer generally used in the art may be used without particular limitation. The polyfunctional acrylate-based monomer may be used either alone or in combination of different kinds thereof.

According to an exemplary embodiment of the present invention, the polyfunctional acrylate-based polymer may have a weight average molecular weight of about 10,000 g/mol to about 100,000 g/mol. If the polyfunctional acrylate-based polymer is in the above range, it has excellent softness and elasticity, so that it may form the cured resin with the acrylate-based monomer, and impart sufficient flexibility to the polarizer protective film including it. If the weight average molecular weight is less than the above range, the adhesion between the hard coating layer and the substrate may be weaken, and if it is more than the above range, the strength of the film may be weaken. The polyfunctional acrylate-based polymer may be used either alone or in combination of different kinds thereof.

Further, the polyfunctional acrylate-based polymer may include the reactive group capable of hydrogen bonding. The reactive group capable of hydrogen bonding may include, for example, a reactive group such as an —OH group, a —NH₂ group, a —NHR group, a —COOH group, a —CONH₂ group, and a —NHOH group, or a residue such as a —NHCO— bond, a —NH— bond, a —CONHCO— bond, and a —NH—NH— bond present in the molecule. If the polyfunctional acrylate-based polymer including the reactive group capable of hydrogen bonding is used, the adhesion to the substrate may be even better, by the role of the reactive group capable of hydrogen bonding in the polyfunctional acrylate-based polymer cured to be included in the hard coating layer.

According to an exemplary embodiment of the present invention, the inorganic fine particles may be inorganic fine particles in nanoscale, for example, nanoparticles having a diameter of about 100 nm or less, for example, about 10 to about 100 nm, preferably about 20 to about 50 nm. Further, the inorganic fine particles may be exemplified as silica nanoparticles, aluminum oxide fine particles, titanium oxide fine particles, zinc oxide fine particles, and the like. The hardness and the scratch resistance of the polarizer protective film may be further improved by including the inorganic fine particles.

According to an exemplary embodiment of the present invention, the inorganic fine particles may be included in about 10 to about 70 parts by weight, preferably about 30 to about 60 parts by weight, based on 100 parts by weight of the cured resin. If the inorganic fine particles are included in above range, the polarizer protective film having both excellent hardness and flexibility may be provided.

According to an exemplary embodiment of the present invention, the substrate may be exemplified as, but not limited to, a polyethylene terephthalate (PET) film, a cyclic olefin copolymer (COC) film, a polyacrylate (PAC) film, a polycarbonate (PC) film, a polyethylene (PE) film, a polymethyl methacrylate (PMMA) film, a polyetheretherketone (PEEK) film, a polyethylene naphthalate (PEN) film, a polyetherimide (PEI) film, a polyimide (PI) film, a triacetyl cellulose (TAC) film, and the like, and any substrate film generally used for protection of a polarizer is applicable without particular limitation.

The polarizer protective film of the present invention as described above may be formed by applying the resin composition including the photocurable monofunctional monomer, the polyfunctional acrylate-based monomer, the polyfunctional acrylate-based polymer, the inorganic fine particles, the photopolymerization initiator, and the solvent on the substrate, and then curing the composition.

The photoinitiator may be exemplified as, but not limited to, 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, bis(2,4,6-trimethylbenzoyl)-phenylphosphine oxide, or the like. Further, as a currently commercially available product, Irgacure 184, Irgacure 500, Irgacure 651, Irgacure 369, Irgacure 907, Darocur 1173, Darocur MBF, Irgacure 819, Darocur TPO, Esacure KIP 100F, and the like may be included. Such photoinitiator may be used either alone or in combination of two or more different kinds thereof.

As the organic solvent, an alcohol-based solvent such as methanol, ethanol, isopropyl alcohol and butanol, an alkoxy alcohol-based solvent such as 2-methoxyethanol, 2-ethoxyethanol and 1-methoxy-2-propanol, a ketone-based solvent such as acetone, methyl ethyl ketone, methyl isobutyl ketone, methyl propyl ketone and cyclohexanone, an ether-based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethyl glycol monopropyl ether, diethyl glycol monobutyl ether and diethylene glycol 2-ethylhexyl ether, an aromatic solvent such as benzene, toluene and xylene, and the like may be used either alone or in combination.

Meanwhile, the resin composition may further include an additive usually used in the art to which the present invention pertains, such as an UV absorbent, a surfactant, an anti-yellowing agent, a leveling agent, an antifouling agent, and the like, in addition to the photocurable monofunctional monomer, the polyfunctional acrylate-based monomer, the polyfunctional acrylate-based polymer, the inorganic fine particles, the photopolymerization initiator, and the solvent, as described above. Further, since the content of the additive may be variously controlled within a range which does not lower the physical properties of the protective film of the present invention, it is not particularly limited.

According to an exemplary embodiment of the present invention, the protective film may be manufactured by the following method.

First, the resin composition including the components described above is applied on the substrate. A method of applying the resin composition is not particularly limited, if it is usable in the art to which the present invention pertains, and for example, a bar coating method, a knife coating method, a roll coating method, a blade coating method, a die coating method, a micro gravure coating method, a comma coating method, a slot die coating method, a lip coating method, or the like may be used.

Next, the protective film may be formed by irradiating the applied resin composition with ultraviolet light to carry out the photocuring reaction. Before irradiation with the ultraviolet light, the drying process may be further carried out in order to planarize the applied surface of the resin composition, and vaporize the solvent included in the composition.

The dose of ultraviolet light may be, for example, about 20 to about 600 mJ/cm². As a light source used in the irradiation of ultraviolet light, any source usable in the art to which the invention pertains may be used without particular limitation, and for example, a high pressure mercury lamp, a metal halide lamp, a black light fluorescent lamp, or the like may be used.

According to another aspect of the present invention, a polarizing plate including a polarizer; and a protective film provided on at least one surface of the polarizer, may be provided, wherein the protective film includes a substrate, and a hard coating layer formed in direct contact with the substrate, on at least one surface of the substrate, the hard coating layer includes a cured resin of a photocurable monofunctional monomer, a polyfunctional acrylate-based monomer, and a polyfunctional acrylate-based polymer, and inorganic fine particles dispersed in the cured resin, and the photocurable monofunctional monomer has a reactive group capable of hydrogen bonding.

The polarizer represents a characteristic capable of extracting only the light vibrating in one direction from the incident light vibrating in various directions. Such characteristic may be attained by stretching iodine-absorbed PVA (polyvinyl alcohol) with a strong tension. For example, more specifically, the polarizer may be formed by immersing the PVA film in an aqueous solution to be swelled, dyeing the swelled PVA film with a dichromatic material to impart a polarizing property to the swelled PVA film, stretching the dyed PVA film to arrange the dichromatic dye material in parallel in a stretching direction (stretching process), and compensating the color of the PVA film stretched by the stretching process (color compensation process). However, the polarizing plate of the present invention is not limited thereto.

The polarizing plate of the present invention includes the polarizer protective film provided on at least one surface of the polarizer. The polarizer protective film includes the substrate, and the hard coating layer formed in direct contact with the substrate, on at least one surface of the substrate, wherein the hard coating layer includes a cured resin of a photocurable monofunctional monomer, a polyfunctional acrylate-based monomer, and a polyfunctional acrylate-based polymer, and inorganic fine particles dispersed in the cured resin. More detailed description thereof, and the manufacturing method of the polarizer protective film are as described above regarding the polarizer protective film.

According to an exemplary embodiment of the present invention, the polarizing plate of the present invention may be manufactured by the following method.

First, the polarizer protective film is formed by carrying out the photocuring reaction after applying the composition including the photocurable monofunctional monomer, the polyfunctional acrylate-based monomer, the polyfunctional acrylate-based polymer, the inorganic fine particles, the photopolymerization initiator, and the solvent on the substrate. More detailed description of the process of forming the protective film is as described above regarding the polarizer protective film.

Next, the polarizing plate of the present invention is obtainable by laminating the formed protective film on the polarizer using an adhesive to be adhered.

However, the polarizing plate of the present invention is not limited thereto, and any manufacturing method of the polarizing plate generally used in the art may be used without particular limitation.

According to an exemplary embodiment of the present invention, the protective film may be adhered to both surfaces of the polarizer.

The polarizer protective film according to an exemplary embodiment of the present invention represents excellent physical and mechanical properties, and the polarizing plate including the film may have excellent adhesion and scratch resistance.

Hereinafter, the function and effect of the invention will be described in detail, through the specific examples of the invention. However, the examples are provided only to illustrate the present invention, and the scope of the invention is in no way determined thereby.

### EXAMPLES

### Preparation of Resin Composition for Adhesion Enhancing Layer

### Preparation Example 1

47.5 wt % of 2-hydroxyethyl acrylate, 2.5 wt % of Irgacure184 as the photopolymerization initiator, and 50 wt % of methyl ethyl ketone as the organic solvent were mixed to prepare the resin composition.

### Preparation Example 2

30 wt % of 2-hydroxyethyl acrylate, 17.5 wt % of pentaerythritol tri(tetra)acrylate, 2.5 wt % of Irgacure184 as the photopolymerization initiator, and 50 wt % of methyl ethyl ketone as the organic solvent were mixed to prepare the resin composition.

### Preparation Example 3

30 parts by weight of isonorbornyl acrylate, 17.5 wt % of pentaerythritol tri(tetra)acrylate, 2.5 wt % of Irgacure184 as the photopolymerization initiator, and 50 wt % of methyl ethyl ketone as the organic solvent were mixed to prepare the resin composition.

### Preparation Example 4

47.5 wt % of pentaerythritol tri(tetra)acrylate, 2.5 wt % of Irgacure184 as the photopolymerization initiator, and 50 wt % of methyl ethyl ketone as the organic solvent were mixed to prepare the resin composition.

### Preparation of Resin Composition for Photocurable Layer Formed on Adhesion Enhancing Layer

### Preparation Example 5

47.5 wt % of pentaerythritol tri(tetra)acrylate, 2.5 wt % of Irgacure184 as the photopolymerization initiator, and 50 wt % of methyl ethyl ketone as the organic solvent were mixed to prepare the resin composition.

### Preparation of Composition for Hard Coating Layer

### Preparation Example 6

17.5 wt % of 2-hydroxyethyl acrylate (HEA), 12.5 wt % of pentaerythritol tri(tetra)acrylate (PETA), 12.5 wt % of nano silica particles, 5 wt % of GH-1203 (available from Shin Nakamura Chemical Co., Ltd, Mw: 14,000) as the polyfunctional acrylate-based polymer, 2.5 wt % of Irgacure184 as the photopolymerization initiator, and 50 wt % of methyl ethyl ketone of the organic solvent were mixed to prepare the resin composition.

### Preparation Example 7

17.5 wt % of tetrahydrofurfuryl acrylate (THFA), 12.5 wt % of pentaerythritol tri(tetra)acrylate (PETA), 12.5 wt % of nano silica particles, 5 wt % of GH-1203 (available from Shin Nakamura Chemical Co., Ltd, Mw: 14,000) as the polyfunctional acrylate-based polymer, 2.5 wt % of Irgacure184 as the photopolymerization initiator, and 50 wt % of methyl ethyl ketone as the organic solvent were mixed to prepare the resin composition.

### Preparation Example 8

27.5 wt % of pentaerythritol tri(tetra)acrylate (PETA), 20 wt % of nano silica particles, 2.5 wt % of Irgacure184 as the photopolymerization initiator, and 50 wt % of methyl ethyl ketone as the organic solvent were mixed to prepare the resin composition.

### Preparation Example 9

17.5 wt % of tetrahydrofurfuryl acrylate (THFA), 30 wt % of pentaerythritol tri(tetra)acrylate (PETA), 2.5 wt % of Irgacure184 as the photopolymerization initiator, and 50 wt % of methyl ethyl ketone as the organic solvent were mixed to prepare the resin composition.

### Preparation of Polarizer Protective Film Including Adhesion Enhancing Layer

### Example 1

The resin composition prepared in above Preparation Example 1 was applied on the acryl-based stretched film having a thickness of 50 μm by the bar coating method, so that the thickness after drying is 4 to 5 μm. After the film applied with the composition was dried at 100° C. for 2 minutes, it was semi-cured with a mercury lamp at 50 mJ/cm².

After the resin composition prepared in above Preparation Example 5 was applied on the semi-cured film in a thickness of 4 to 5 μm, it was dried at 60° C. for 2 minutes, and the dried film was cured with a mercury lamp at 200 mJ/cm².

### Example 2

The polarizer protective film was manufactured in the same manner as in Example 1, except for using the resin composition prepared in above Preparation Example 2, instead of the resin composition prepared in above Preparation Example 1.

### Comparative Example 1

The polarizer protective film was manufactured in the same manner as in Example 1, except for using the resin composition prepared in above Preparation Example 3, instead of the resin composition prepared in above Preparation Example 1.

### Comparative Example 2

The polarizer protective film was manufactured in the same manner as in Example 1, except for using the resin composition prepared in above Preparation Example 4, instead of the resin composition prepared in above Preparation Example 1.

The compositions of the compositions for the adhesion enhancing layers used in above Examples 1 and 2, and Comparative Examples 1 and 2 are listed in following Table 1. The compositions for the adhesion enhancing layers consist of 2.5 wt % of the photopolymerization initiator, and 50 wt % of the organic solvent, in addition to the components listed in the following table.

TABLE 1

| | Photocurable | |
|---|---|---|
| | monofunctional | Polyfunctional |
| | monomer | acrylate-based monomer |
| Remarks | (content: wt %) | (content: wt %) |
| Example 1 | 2-Hydroxyethyl acrylate | — |
| | (47.5) | |
| Example 2 | 2-Hydroxyethyl acrylate | Pentaerythritol tri(tetra)acrylate |
| | (30) | (17.5) |
| Comparative | Isobornyl acrylate | Pentaerythritol tri(tetra)acrylate |
| Example 1 | (30) | (17.5) |
| Comparative | — | Pentaerythritol tri(tetra)acrylate |
| Example 2 | | (47.5) |

### Preparation of Polarizer Protective Film Including Hard Coating Layer

### Example 3

After the resin composition prepared in Preparation Example 6 was applied on the acryl-based stretched film having a thickness of 50 μm by the bar coating method, it was dried at 100° C. for 2 minutes. The thickness of the applied composition after drying was 5 μm. After dried, it was cured with the mercury lamp at 200 mJ/cm² to manufacture the polarizer protective film.

### Example 4

The polarizer protective film was manufactured in the same manner as in Example 1, except for using the resin composition prepared in Preparation Example 7, instead of the resin composition prepared in Preparation Example 6.

### Comparative Example 3

The polarizer protective film was manufactured in the same manner as in Example 1, except for using the resin composition prepared in Preparation Example 8, instead of the resin composition prepared in Preparation Example 6.

### Comparative Example 4

The polarizer protective film was manufactured in the same manner as in Example 1, except for using the resin composition prepared in Preparation Example 9, instead of the resin composition prepared in Preparation Example 6.

The compositions of the resin compositions used in above Examples 3 and 4, and Comparative Examples 3 and 4 are listed in following Table 1-1, and the resin compositions include 2.5 wt % of the photopolymerization initiator, and 50 wt % of the organic solvent, in addition to the compositions listed in following Table 1-1.

TABLE 1-1

| | Photocurable | | | |
|---|---|---|---|---|
| | mono- | | | Inorganic |
| | functional | Polyfunctional | Polyfunctional | fine |
| | monomer | acrylate-based | acrylate-based | particles |
| | (content: | monomer | polymer | (content: |
| | wt %) | (content: wt %) | (content: wt %) | wt %) |
| Example 3 | HEA | PETA | GH-1203 | 12.5 |
| | (17.5) | (12.5) | 5 | |
| Example 4 | THFA | PETA | GH-1203 | 12.5 |
| | (17.5) | (12.5) | 5 | |
| Comparative | — | PETA | — | 20 |
| Example 3 | | (27.5) | | |
| Comparative | THFA | PETA | — | — |
| Example 4 | (17.5) | (30) | | |

### Experimental Examples

### Adhesion Strength Experiment

Adhesion strength for the polarizer protective films prepared in above Examples 1 and 2, and Comparative Examples 1 and 2 was tested by a cross-cut tape method. After 11 vertical and 11 horizontal lines were made in 1 mm distance with a knife on the cured polarizer protective film, the adhesion strength was evaluated according to the area where the film was not removed, after attaching adhesive tape then suddenly detaching it. The case where the film-remaining area is 100% was evaluated to be 5B, the case of 95 to 99% was 4B, the case of 85 to 94% was 3B, the case of 65 to 84% was 2B, the case of 35 to 64% was 1B, and the case of 34% or less was 0B. The experiment results are listed in following Table 2.

TABLE 2

| Remarks | Adhesion strength |
|---|---|
| Example 1 | 4B |
| Example 2 | 5B |
| Comparative Example 1 | 1B |
| Comparative Example 2 | 0B |

From the results of above Table 2, it is appreciated that the polarizer protective film of Examples 1 and 2 show better adhesion strength than the polarizer protective film of Comparative Examples 1 and 2. This may be construed as due to better adhesion between the substrate and the adhesion enhancing layer, which is resulted from the fact that the reactive group capable of hydrogen bonding may be provided in the adhesion enhancing layer of the polarizer protective film of the present invention, and after curing, intermolecular hydrogen bonding is possible on the interface between the adhesion enhancing layer and the substrate, as described above.

### Adhesion Strength Experiment

Meanwhile, adhesion strength for the polarizer protective films prepared in above Examples 3 and 4, and Comparative Examples 3 and 4 was also tested by the cross-cut tape method. After 11 vertical and 11 horizontal lines were made in 1 mm distance with a knife on the cured polarizer protective film, the adhesion strength was evaluated according to the area where the film was not removed after attaching adhesive tape then suddenly detaching it. The case where the film-remaining area is 100% was evaluated to be 5B, the case of 95 to 99% was 4B, the case of 85 to 94% was 3B, the case of 65 to 84% was 2B, the case of 35 to 64% was 1B, and the case of 34% or less was 0B.

### Scratch Resistance Experiment

A friction tester was equipped with steel wool (#0000), and each of sleds with different weights was moved back and forth 10 times on the polarizer protective film manufactured in above Examples 3 and 4, and Comparative Examples 3 and 4. After moving, the weight of the sled which made two or less scratches on the polarizer protective film surface was observed.

The experiment results for the adhesion strength, and the scratch resistance tests are listed in following Table 2-2.

TABLE 2-2

| Remarks | Adhesion strength | Scratch resistance |
|---|---|---|
| Example 3 | 5B | 500 g |
| Example 4 | 4B | 400 g |
| Comparative Example 3 | 0B | 500 g |
| Comparative Example 4 | 4B | 50 g |

It is appreciated that the films of Examples 3 and 4 have generally better adhesion strength and scratch resistance than those of Comparative Examples 3 and 4. Particularly, while Comparative Example 3 shows excellent scratch resistance, and Comparative Example 4 shows excellent adhesion strength, Examples 3 and 4 show both excellent adhesion strength and scratch resistance.

Such results show that the polarizer protective films of Examples 3 and 4 have excellent adhesion strength by the action of the photocurable monofunctional monomer, and excellent scratch resistance by the action of the inorganic fine particles.

### REFERENCE SIGNS LIST

10: Substrate
20: Adhesion enforcing layer
21: Eroded part of substrate
30: Photocurable layer
100: Substrate
200: Hard coating layer
210: Eroded part of substrate

1. A polarizer protective film comprising:
a substrate;
an adhesion enhancing layer formed to erode the substrate by directly contacting the substrate on at least one surface of the substrate; and
a photocurable layer formed on the adhesion enhancing layer,
wherein the adhesion enhancing layer has a thickness of 1 to 10 μm, and includes a cured resin of a photocurable monofunctional monomer having a reactive group capable of hydrogen bonding.

2. The polarizer protective film of claim 1, wherein the adhesion enhancing layer includes a cured resin of the photocurable monofunctional monomer having the reactive group capable of hydrogen bonding and a polyfunctional acrylate-based monomer.

3. The polarizer protective film of claim 1, wherein the reactive group capable of hydrogen bonding is a reactive group including an —OH group, a —NH₂ group, a —COOH group, a —CONH₂ group, or a —NHOH group; or a reactive group including a —NH— bond, a —NH—NH— bond, a —NHCO— bond, or a —CONHCO— bond.

4. The polarizer protective film of claim 2, wherein the polyfunctional acrylate-based monomer includes one or more selected from the group consisting of hexanediol diacrylate (HDDA), tripropylene glycol diacrylate (TPGDA), ethylene glycol diacrylate (EGDA), trimethylolpropane triacrylate (TMPTA), trimethylolpropane ethoxylated triacrylate (TMPEOTA), glycerol propoxylated triacrylate (GPTA), pentaerythritol tetraacrylate (PETA), and dipentaerythritol hexaacrylate (DPHA).

5. The polarizer protective film of claim 1, wherein the substrate includes one or more selected from the group consisting of a polyethylene terephthalate (PET) film, a cyclic olefin copolymer (COC) film, a polyacrylate (PAC) film, a polycarbonate (PC) film, a polyethylene (PE) film, a polymethylmethacrylate (PMMA) film, a polyetheretherketone (PEEK) film, a polyethylene naphthalate (PEN) film, a polyetherimide (PEI) film, a polyimide (PI) film, and a triacetyl cellulose (TAC) film.

6. The polarizer protective film of claim 1, wherein the photocurable layer is an anti-reflective layer, an antiglare layer, or a scratch resistant layer.

7. The polarizer protective film of claim 1, further comprising a hard coating layer between the adhesion enhancing layer and the photocurable layer.

8. A manufacturing method of a polarizer protective film, comprising:
applying a first composition for forming an adhesion enhancing layer on at least one surface of a substrate;
carrying out a first photocuring by irradiating the applied first composition with ultraviolet light;
applying a second composition for forming a photocurable layer on the first composition cured in the first photocuring; and
carrying out a second photocuring by irradiating the applied second composition with ultraviolet light,
wherein the first composition includes a photocurable monofunctional monomer having a reactive group capable of hydrogen bonding, a photopolymerization initiator, and the second composition includes a photocurable compound and the photopolymerization initiator.

9. The manufacturing method of claim 8, wherein the reactive group capable of hydrogen bonding is a reactive group including an —OH group, a —NH₂ group, a —COOH group, a —CONH₂ group, or a —NHOH group; or a reactive group including a —NH— bond, a —NH—NH— bond, a —NHCO— bond, or a —CONHCO— bond.

10. The manufacturing method of claim 8, wherein the first composition includes the photocurable monofunctional monomer having the reactive group capable of hydrogen bonding, a polyfunctional acrylate-based monomer and the photopolymerization initiator.

11-15. (canceled)

16. A polarizer protective film comprising:
a substrate; and
a hard coating layer formed in direct contact with the substrate, on at least one surface of the substrate,
wherein the hard coating layer includes a cured resin of a photocurable monofunctional monomer, a polyfunctional acrylate-based monomer, and a polyfunctional acrylate-based polymer, and inorganic fine particles dispersed in the cured resin; and the photocurable monofunctional monomer has a reactive group capable of hydrogen bonding.

17. The polarizer protective film of claim 16, wherein the hard coating layer has a thickness of 1 to 10 μm.

18. The polarizer protective film of claim 16, wherein 10 to 80 parts by weight of the photocurable monofunctional monomer, 10 to 80 parts by weight of the polyfunctional acrylate-based monomer, and 5 to 30 parts by weight of the polyfunctional acrylate-based polymer are cured, based on 100 parts by weight of the cured resin.

19. The polarizer protective film of claim 16, wherein the photocurable monofunctional monomer has a reactive group including an —OH group, a —NH₂ group, a —COOH group, a —CONH₂ group, or a —NHOH group; or a functional site including a —NH— bond, a —NH—NH— bond, a —NHCO— bond, or a —CONHCO— bond.

20. The polarizer protective film of claim 16, wherein the polyfunctional acrylate-based monomer includes one or more selected from the group consisting of hexanediol diacrylate (HDDA), tripropylene glycol diacrylate (TPGDA), ethylene glycol diacrylate (EGDA), trimethylolpropane triacrylate (TMPTA), trimethylolpropane ethoxylated triacrylate (TMPEOTA), glycerol propoxylated triacrylate (GPTA), pentaerythritol tetraacrylate (PETA), and dipentaerythritol hexaacrylate (DPHA).

21-22. (canceled)

23. The polarizer protective film of claim 16, wherein the inorganic fine particles include one or more selected from the group consisting of silica nanoparticles, aluminum oxide fine particles, titanium oxide fine particles, and zinc oxide fine particles.

24. (canceled)

25. The polarizer protective film of claim 16, wherein the substrate includes one or more selected from the group consisting of a polyethylene terephthalate (PET), a cyclic olefin copolymer (COC), a polyacrylate (PAC), a polycarbonate (PC), a polyethylene (PE), a polymethylmethacrylate (PMMA), a polyetheretherketone (PEEK), a polyethylene naphthalate (PEN), a polyetherimide (PEI), a polyimide (PI), and a triacetyl cellulose (TAC).

26. A polarizing plate comprising:
a polarizer; and
a protective film provided on at least one surface of the polarizer,
wherein the protective film includes a substrate, and a hard coating layer formed in direct contact with the substrate, on at least one surface of the substrate; the hard coating layer includes a cured resin of a photocurable monofunctional monomer, a polyfunctional acrylate-based monomer, and a polyfunctional acrylate-based polymer, and inorganic fine particles dispersed in the cured resin; and the photocurable monofunctional monomer has a reactive group capable of hydrogen bonding.

27. (canceled)

28. The polarizing plate of claim 26, wherein 10 to 80 parts by weight of the photocurable monofunctional monomer, 10 to 80 parts by weight of the polyfunctional acrylate-based monomer, and 5 to 30 parts by weight of the polyfunctional acrylate-based polymer are cured, based on 100 parts by weight of the cured resin.

29. The polarizing plate of claim 26, wherein the photocurable monofunctional monomer has a reactive group including an —OH group, a —NH₂ group, a —COOH group, a —CONH₂ group, or a —NHOH group; or a functional site including a —NH— bond, a —NH—NH— bond, a —NHCO— bond, or a —CONHCO— bond.

30-31. (canceled)
